(19) United States
(12) Patent Application Publication
(10) Pub. No.: US 2018/0285402 A1
(43) Pub. Date: Oct. 4, 2018

(54) System and Method for Expertise Mapping

(71) Applicant: CA, Inc., New York, NY (US)

(72) Inventors: Michael Cohen, Flushing, NY (US); Simon Cockayne, Charlottesville, VA (US)

(21) Appl. No.: 15/470,967

(22) Filed: Mar. 28, 2017

(51) Int. Cl. G06F 17/30

(52) U.S. Cl. CPC G06F 17/30345; G06F 17/30684; G06F 17/30917

(57) ABSTRACT

A computer-implemented expertise mining system is configured to update an expertise database based on a recommender's out of office and/or auto-reply settings for a communication application, such as an email application or social media application. The expertise system obtains the recommender's auto-reply settings directly from the communication application. The auto-reply settings include message body text for out of office and auto-reply messages. The expertise system then extracts recommendation data from the auto-reply settings; and updates an expertise database based on the recommendation data extracted from the auto-reply settings.

### TECHNICAL FIELD

The present disclosure relates generally to expertise mining systems for and, more particularly, to a system for enhancing expertise mapping in an expertise mining system based on out-of-office or other auto-reply settings in email and social media applications.

### BACKGROUND

Expertise mining systems attempt to augment or replace traditional declarative-based expertise catalogs with information dynamically extracted from email and other social media communications, in order to identify parties in an organization that have expertise on a particular subject. There is a wide body of literature on natural language processing (NLP) techniques that may be used to identify parties, subjects, and sentiments (question, answer, declaration) expressed in email and social media communications. Beyond the complexities of NLP lies the challenge of classifying and prioritizing parties accurately in order to determine which of the parties actually has useful expertise in a given subject, the level of expertise of the parties, and which parties currently are responsible for involvement with a given subject. For example, the mere fact that a party has answered questions about a subject does not mean that the party is particularly qualified in that subject.

Existing expertise mining systems often attempt to rate the expertise of someone based on the frequency of their participation or replies to a subject, but these frequencies do not imply accuracy or breadth of knowledge. Existing solutions may additionally use certain rating criteria such as the number of “likes” of a post to raise the score of a responder, but such criteria depend on the end user bothering to provide “likes”, and result in somewhat subjective results. It is desirable that the inferences made by NLP-based expertise mining systems currently based on heuristics, such as who has participated in discussions or who answered questions about a particular topic, be further scored or ranked based on more objective criteria to improve the accuracy and reliability of the rankings.

### SUMMARY

The present invention relates to an expertise mining system that improves accuracy of expert classification and ranking in expertise mining systems by using “out-of-office” or auto-reply message settings obtained from an email application, social media application, or other communication application. The auto-reply settings may include message body text designating or recommending particular individuals, i.e. recommendees, as being responsible for particular matters in the absence of the recommender. Compared to other data sources and heuristics, the designations of the recommender are more reliable indicators of the expertise and current responsibilities of the recommender and the recommendee, and can be used to augment the ratings or scorings generated by analyzing other data sources and heuristics.

Embodiments of the present disclosure leverage statements made by recommenders in “out-of-office” or “auto-reply” messages during the course of carrying out or ensuring the continuity of the recommender's responsibilities, thus providing more definitive and objective expertise mappings that can be used to generate new expertise mappings, or raise the score associated with an existing expertise mapping. In contrast to outdated skills catalogs or training records that don't reflect what an individual actually does on a day-to-day basis, the statements contained in the message body of “out-of-office” and “auto-reply” messages provide more reliable and definitive current expressions of the recommender's current responsibilities, and of the capabilities of those individuals designated as replacements during the recommender's absence.

### BRIEF DESCRIPTION OF THE DRAWINGS

FIG. 1 illustrates an exemplary communication network including an expertise mining system as herein described.

FIG. 2 illustrates an exemplary structure of an expertise database used by an expertise mining system.

FIG. 3 is a functional block diagram of an expertise mining system according to an embodiment.

FIG. 4 is a flow chart illustrating an exemplary method implemented by an expertise mining system of creating or updating expertise mappings.

FIG. 5 is a flow chart illustrating another exemplary method implemented by an expertise mining system of creating or updating expertise mappings.

FIG. 6 illustrates an exemplary computer configured to create and update expertise mappings.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded on to a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

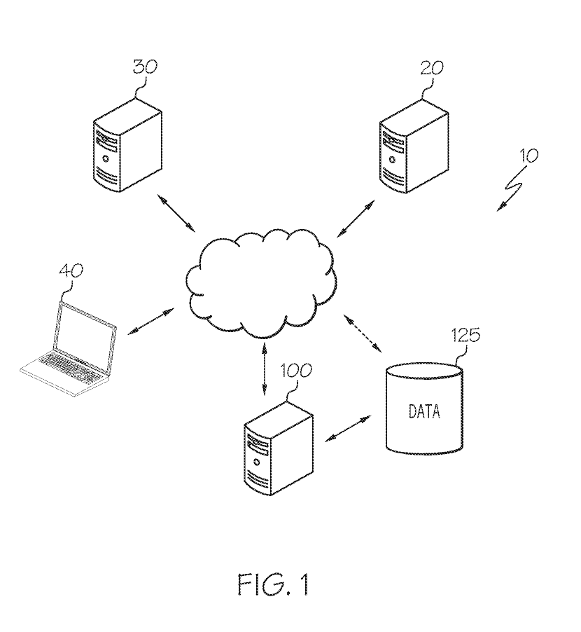

Referring now to the drawings, FIG. 1 illustrates a typical deployment of an expertise mining system 100 within a communication network 10. The communication network 10 may comprise any network capable of exchanging signals between networked devices. The network 10 may, for example, comprise a local area network (LAN), a wide area network (WAN), a wireless LAN (WLAN), a cellular network, and/or an optical network. In some embodiments, the network 10 may comprise two or more interconnected networks using the same network technologies or different network technologies. The communication network 10 may be a circuit-switched network, a packet-switched network, or a combination of circuit-switched and packet-switched networks. The network 10 may comprise any number of networking devices such as routers, gateways, switches, hubs, firewalls, and the like (not shown) supporting the routing and exchange of signals. In the exemplary embodiment shown in FIG. 1, the communication network 10 comprises a mail server 20, an application server (AS) 40, the expertise mining system 100, and one or more user devices 60.

The mail server 20 comprises a message transfer agent (MTA) that is configured to send and receive email messages on behalf of mail clients. Exemplary mail servers 20 comprise the MICROSOFT EXCHANGE SERVER® for the Windows operating system, SENDMAIL®; for UNIX/LINUX operating systems, and POSTFIX®. The mail server may run on a WINDOWS® operating system, OSX® operation system, UNIX operating system, LINUX operating system, or other operating systems.

Mail servers typically include an auto-reply function that enables mail users to send automatic replies when the user is out of the office or otherwise unavailable. The mail system provides a user interface that enables users to configure auto-reply settings. As used herein, the term “auto-reply” settings includes configuration settings for any automatically generated reply message including out-of-office messages. The auto-reply settings typically include a user name of the user to which the settings apply, a start date/time when the mail system begins sending the auto-reply messages, and end date/time when the mail system stops sending auto-reply messages, and message body text for the auto-reply message. For example, a user named Bob may have the following auto-reply settings.

TABLE 1
Example Auto-reply/Out-of-Office Settings

| | |
|---|---|
| Username | Bob |
| Start date/time | Jan. 21, 2017, 12:00 p.m |
| End date/time | Jan. 24, 2017, 8:30 a.m |
| Message body text | “I will be out of the office from noon on Jan. |
| | 21, 2017 until the morning of Jan. 24, 2017. |
| | If you need assistance with virtualization |
| | technologies, please contact Mary Brown.” |

The application server 30 comprises a server that is configured to support web-based or network-based social media applications. Some popular social media applications include FACEBOOK®, WHATS APP®, INSTAGRAM®, TWITTER®, PINTEREST®, and SNAPCHAT®. Social media applications may include a presence feature that indicates a presence status of a user and provides auto-reply messages based on the presence status. Users may configure the auto-reply settings for social media applications in essentially the same manner as the auto-reply settings for email services.

Expertise mining system 100 is a knowledge management system that is configured to organize knowledge about experts within an organization. The purpose of the expertise mining system 100 is to identify experts within an organization having knowledge on specific topics or subjects. Most expertise mining systems 100 in use today rely on employees completing a self-assessment of competencies. Employees may also be asked to express opinions about competencies of other persons within the organization. One problem with self-assessments is that they are highly subjective and difficult to normalize. Additionally, self-assessments may be biased by the person's self-perception or by a person's speculation about the intended use of the self-assessment.

Many expertise mining systems 100 also use data mining techniques to extract information about the competencies of individuals within an organization. Data mining refers to techniques for extracting knowledge or identifying patterns in a large collection of data. Within an organization, a large number of documents are typically generated which can be “mined” to extract knowledge about the competencies and expertise of persons within the organization. The extraction of knowledge can be automated using natural language processing (NLP) techniques. Applying NLP techniques to documents generated within an organization provides useful insights into the competencies and experiences of persons within the organization. NLP techniques can be applied to virtually any document, including emails and social media conversations. However, unstructured, open-ended conversations are challenging for NLP processors. Further, it is difficult to determine the reliability of the source or to reliably generate competency scores. Another problem with the use of emails and social media conversations for data mining is that the sources may reflect a person's activities, but not necessarily their responsibilities within an organization.

In exemplary embodiments of the present disclosure, auto-reply and/or out-of-office settings stored in mail servers 20 and application servers 30 for social media applications are used as an additional source of information for enhanced expertise mining. It is common practice for persons within an organization to make referrals or recommendations to the message recipients when the user is out of the office or otherwise unavailable. The auto-reply settings may include message body text designating or recommending certain individuals to contact for assistance with a particular subject in the absence of the recommender.

Compared to other data sources and heuristics, designations of a recommender made in an auto-reply message are more reliable indicators of the expertise and current responsibilities of both the recommender and the recommended persons. The information contained in the auto-reply settings can be used to augment the ratings or competency scores generated by analyzing other data sources and heuristics, or to generate scores if none exist. The auto-reply settings can be obtained directly from a mail server 20 or application server 30 by periodically polling the server 20, 40 to obtain current settings for persons within the organization. The auto-reply settings can be stored in a historical settings database and the age of the information or longevity may be used to adjust or weight competency scores.

Using the techniques herein described, it is not necessary to extract information from actually transmitted emails, because the auto-reply settings can be obtained directly from the mail server 20 or application server 30. The information extracted from auto-reply settings can be treated as reliable indicators of the expertise and current responsibilities of both the recommender and the recommended persons. Scoring algorithms in expertise mining systems 100 can be modified to provide greater weight to the information obtained from auto-reply and out-of-office settings compared to other data sources and heuristics.

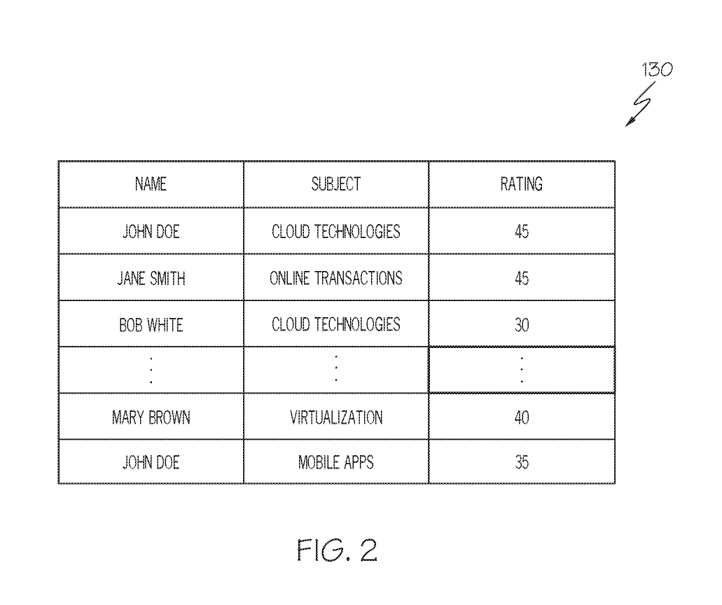

FIG. 2 illustrates an exemplary data structure 130 of an expertise database 125 for an expertise mining system 100 for storing expertise mappings. The exemplary data structure is in the form of a table, although other types of data structures could be used. The data structure includes, for each individual, the individual's name, area of expertise (denoted subject), and competency score (denoted rating). In the data structure shown in FIG. 2, each row represents an expertise mapping for one individual and each column represents a field. An individual may appear more than once in the table if the person has competencies in more than one subject. In the example shown in FIG. 2, John Doe has a competency score in two areas, cloud technologies and mobile apps, and so appears twice in the table.

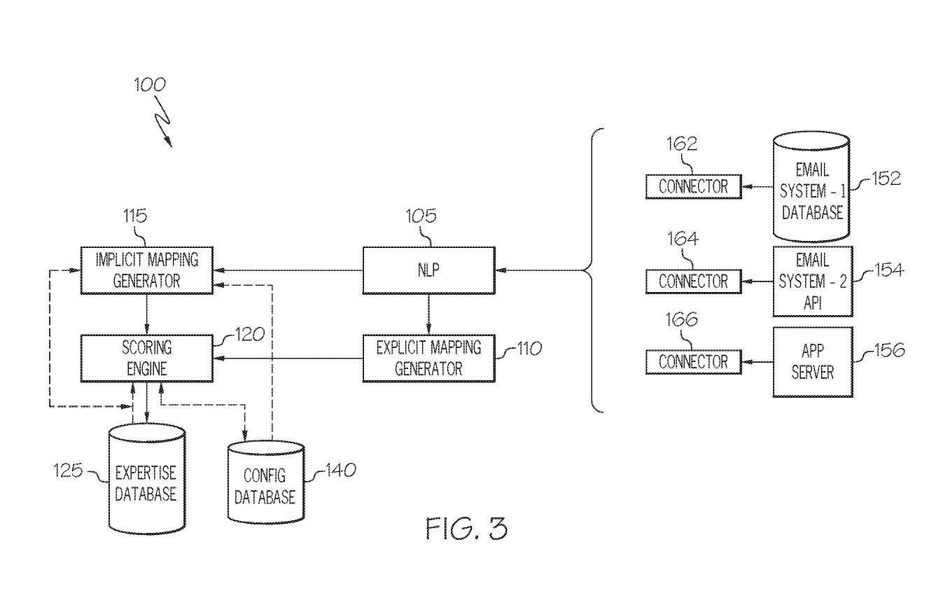

FIG. 3 illustrates the main functional components of an expertise mining system 100. The expertise mining system 100 comprises a natural language processor 105, an explicit mapping generator 110, an implicit mapping generator 115, a scoring engine 120, an expertise database 125, and a configuration database 140. The natural language processor 105, explicit mapping generator 110, implicit mapping generator 115, and scoring engine 120 may comprise one or more microprocessors, microcontrollers, hardware, firmware, or a combination thereof. The functional components of the expertise mining system 100 may be implemented in a single computing device with one or more processors, or by multiple computing devices.

Data from one or more data sources is input to the natural language processor 105. In the exemplary embodiment shown in FIG. 3, the data sources comprise a first email system 152, a second email system 154, and an application server 156 for a social media service. Data sources 152, 154, and 156 provide information to the natural language processor 105 via connectors 162, 164, and 166. The connectors 162, 164, and 166 comprise software components that handle communication with the data sources 152, 154, and 156 and provide information obtained from the data sources 152, 154, and 156 to the natural language processor 105. In the exemplary embodiment, the first email system 152 includes a database that stores auto-reply settings. The connector 162 can query the email server's database to obtain the auto-reply settings and provide the auto-reply settings to the natural language processor 105. The second email system 154 includes an application programming interface (API) that exposes the auto-reply settings to authorized users. The connector 164 may send a request to email server or email system 20 to request the auto-reply settings. Assuming that the requester is authorized, the email server 154 sends a response including the auto-reply settings back to the connector 164, which forwards the auto-reply settings to the natural language processor 105. Connector 166 can obtain auto-reply settings for a social media application in a manner similar to connector 162 or 164. The connectors 162, 164, and 166 may be implemented on the same computing device as the expertise mining system 100, or on a separate computing device.

The natural language processor 105 is responsible for parsing the information received from the data sources 152, 154, 156 to extract information that reflects the expertise of a recommender and/or a recommended party. The information relevant for the expertise mining system 100 includes the identity of the recommender, the identity of a recommended party, and a subject linked to a recommended party. Due to the highly structured nature of auto-reply messages, the natural language processor 105 is able to extract information relevant for expertise mapping from the message body text in a more reliable fashion as compared to other sources. In general, the natural language processor 105 performs tokenization, tagging of parts of speech (POS), parse stream generation, and subject/entity identification.

The data generated by the natural language processor 105 is provided to the explicit mapping generator 110 and/or implicit mapping generator 115. The explicit mapping generator 110 analyzes the output of the natural language processor 105 in cases where the recommender explicitly links a recommended person with a subject. The explicit mapping generator generates explicit expertise mappings for such cases and supplies the expertise mappings to the scoring engine 120.

The implicit expertise mapping generator 115 similarly analyzes output of the natural language processor 105 in cases where a recommended person is not explicitly linked to a subject. For example, the message body text may indicate a person to contact but without identifying a subject. When a subject is not identified or explicitly linked with a recommended person, the implicit mapping generator 115 may use supplemental information from other sources to infer an expertise mapping. For example, the implicit mapping generator 115 may obtain pre-existing expertise mappings for the recommender from the expertise database 125. In this case, it may be inferred as a heuristic that expertise mappings relevant to the recommender are also relevant to the person being recommended. The implicit mapping generator 115 may employ various techniques to determine whether to infer an expertise mapping. For example, a configuration database 140 may store a series of rules to be applied by the implicit mapping generator 115. As one example, the configuration database 140 may include a rule that persons designated as “administrative assistants” do not inherit implicit expertise mappings from recommenders.

The explicit mapping generator 110 and implicit mapping generator 115 output expertise mappings to the scoring engine 120. The scoring engine 120 filters out duplicate expertise mappings, resolves conflicts between different expertise mappings, and generates appropriate competency scores. The scoring engine 120 is also responsible for updating the expertise database 125. The scoring engine 120 may generate new expertise mappings in appropriate cases, or update existing expertise mappings. For example, the scoring engine 120 may increment an existing competency score where the expertise mapping generated by the implicit or explicit expertise mapping generator 110, 115 matches an existing expertise mapping in the expertise database 125.

The expertise database 125 comprises any database system for storing expertise mappings. The particular type of database used is not a material aspect of the present disclosure. The expertise database may comprise a relational database management system (RDMS) such as SQL SERVER®, SYBASE®, or MYSQL®. RDBMS systems store data in columns and rows, which in turn make up tables. A set of tables makes up a schema. A number of schemas create a database. The expertise database 125 may also be implemented using a NoSQL or object-oriented database. These do not follow the table/row/column approach of RDBMS. Instead, they build bookshelves of elements and allow access per bookshelf.

The configuration database 140 stores and organizes configuration information used by the expertise mining system 100. Information stored in the configuration database 140 may include, for example, conflict resolution rules, rules for inferring expertise mappings, and scoring rules for generating competency scores. As with the expertise database, the configuration database can use a variety of database systems.

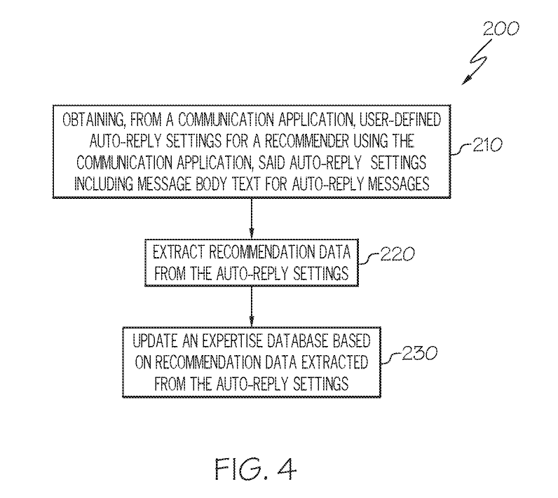

FIG. 4 illustrates an exemplary method 200 implemented by an expertise mining system 100. The expertise mining system 100 obtains, from a communication application, user-defined auto-reply settings for a recommender using a communication application (block 210). As used herein, the term communication application refers to applications used for communicating with a person or a group of persons, including email applications and social media applications. The auto-reply settings typically include a message body text for the auto-reply messages. For example, the message body text may include messages such as:
“For questions about virtualization technologies, please contact Mary Brown.” and “In my absence, please contact Bob White.”
   The expertise mining system 100 extracts recommendation data from the auto-reply settings (block 220). The recommendation data may include information such as the name or identity of the recommender, the name or identity of a recommended person, and a topic or subject linked to the recommended person. In some embodiments, the expertise mining system 100 may optionally obtain supplemental information for generating expertise mappings from an expertise database 125, configuration database 140, or other source. The supplemental information may, for example, be used to infer areas of expertise for recommended persons. Based on the recommendation data extracted from the auto-reply settings, the expertise mining system 100 updates an expertise database (block 230). In this step, the expertise mining system may create a new expertise mapping in the expertise database, or adjust a competency score for an existing expertise mapping in the expertise database.

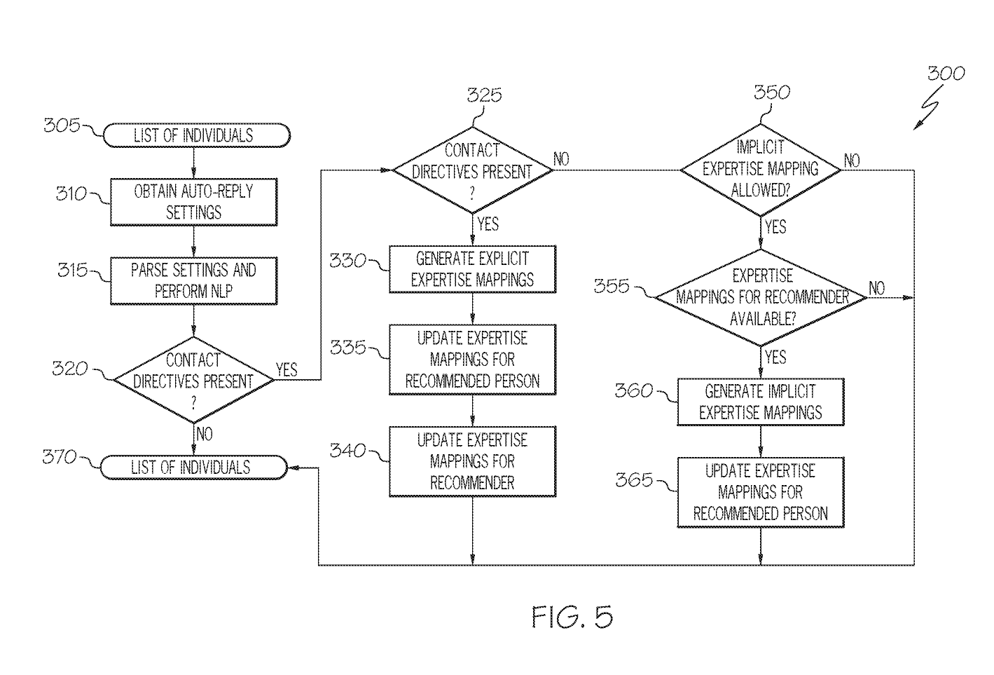

FIG. 5 is a more detailed flow chart illustrating one exemplary method 300 of enhancing accuracy of expertise mappings based on auto-reply and/or out-of-office messages. The method 300 begins with a list of persons within an organization (block 305). The list may include, for example, user names and/or user identities for various communication applications (e.g. email and social media applications). For each person in the list, the expertise mining system 100 obtains the auto-reply settings for that person from one or more communication applications (block 310). As previously noted, some applications may store auto-reply settings in a database that may be queried. Other applications, such as MICROSOFT EXCHANGE SERVER®, may provide an API that can be queried to obtain the auto-reply settings for a user. At block 315, the expertise mining system 100 parses the auto-reply settings to extract recommendation data from the auto-reply settings. During the parsing step, natural language processor 105 processes the message body text in the auto-reply settings to identify recommended persons and corresponding subjects explicitly linked to the recommended persons. At block 320, the expertise mining system 100 determines whether the message body text contains any recommendations or contact directives. As used herein, a contact directive is a declarative statement of a recommender indicating that another person or entity should be contacted and may, or may not, be linked with a subject. At step 325, the expertise mining system 100 determines whether the recommendation or contact directive is linked with a subject. If so, the explicit mapping generator 110 generates an explicit expertise mapping based on the recommendation or contact directive contained in the auto-reply message (block 330). In this case, the explicit expertise mapping is passed to the scoring engine 120, which as previously noted generates a competency score and updates the expertise database 125 (block 335-340). In the embodiment shown in FIG. 5, the scoring engine 120 adds an expertise mapping or updates an existing expertise mapping for the recommended person (block 335). In one embodiment, a new highly rated expertise mapping is added for the recommended person, or a competency score associated with an existing expertise mapping is increased. The expertise mining system also adds or updates an expertise mapping for the recommender (block 340). In one embodiment, a new highly rated expertise mapping is added for the recommended person, or a competency score associated with an existing expertise mapping is increased. In one embodiment, a new medium rated expertise mapping is added for the recommender, or a competency score associated with an existing expertise mapping for the recommender is increased.

Returning to block 325, if the recommendation or contact directive does not include a subject, the implicit mapping generator 115 may attempt to infer an expertise mapping using supplemental information (blocks 350-365). In one embodiment, the implicit mapping generator 115 determines whether implicit expertise mappings for the recommended person are allowed (block 350). This information is obtained by querying the configuration database 140 to obtain any mapping rules that apply to the recommended person. If implicit expertise mapping is not allowed for the recommended person, the process ends (block 370). If implicit expertise mapping is allowed for the recommended party, the implicit mapping generator 115 determines whether any expertise mappings exist for the recommender (block 355). This information is obtained by querying the expertise database 125. If so, the implicit mapping generator 115 generates an implicit expertise mapping consistent with any applicable mapping rules and passes the implicit expertise mapping to the scoring engine 120 (block 360). The scoring engine 120 updates the expertise database 125 based on the implicit expertise mapping (block 365). In one embodiment, the scoring engine 120 adds a new low-rated expertise mapping for the recommended party to the expertise database. If an expertise mapping for the inferred subject already exists, the scoring engine may leave the existing expertise mapping unchanged, or slightly modify the competency score for the existing expertise mapping.

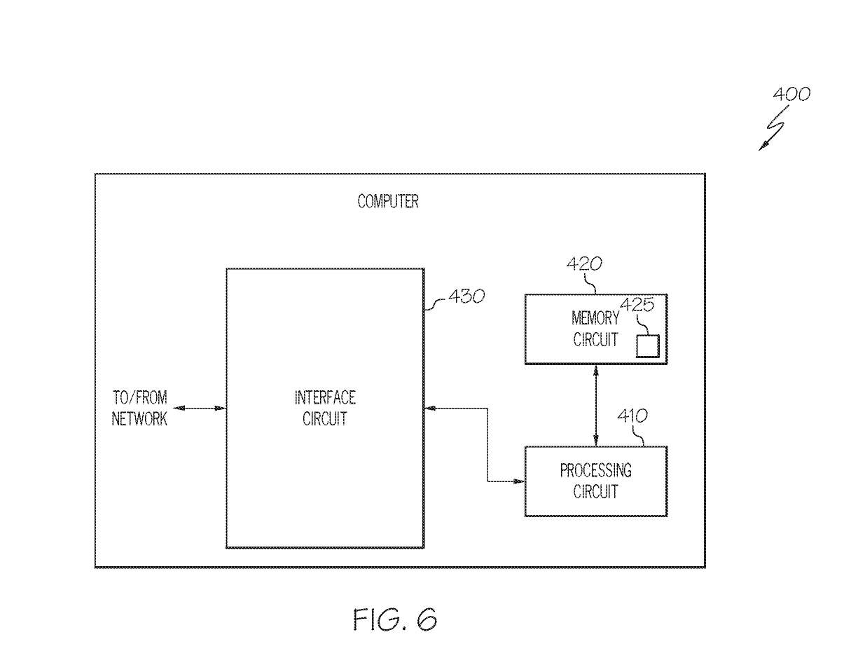

FIG. 6 is a functional block diagram illustrating some components of an exemplary control computer 400 configured to operate according to one or more embodiments. As seen in FIG. 6, computer 400 comprises a programmable processing circuit 410, a memory circuit 420, and an interface circuit 430. The processing circuit 410 may be implemented by one or more microprocessors, hardware, firmware, or a combination thereof, and controls the operation of computer 400 according to the embodiments previously described. Such operations include, but are not limited to obtaining auto-reply settings from a communication application, performing NLP of auto-reply settings to extract recommendation data, generating expertise mappings based on the recommendation data, and updating an expertise database.

Memory circuit 420 may comprise any non-transitory, solid state memory or computer readable media known in the art. Suitable examples of such media include, but are not limited to, ROM, DRAM, Flash, or a device capable of reading computer-readable storage media, such as optical or magnetic media. Memory circuit 420 stores an expertise mapping application 425 that when executed by the processing circuit 410, causes the computer 400 to perform the methods previously described according to embodiments of the present disclosure. In some embodiments, memory circuit 410 may also store the expertise database 125 and configuration database 140.

The interface circuit 430 comprises a transceiver or other communications interface that facilitates the communication of data (e.g., performance metrics) with the email server 20, application server 30, user devices 40, or other networked devices. Although the interface circuit 430 may communicate data according to any known protocol, the interface circuit 430 in one embodiment comprises an interface card that operates according to any of standards defining the well-known ETHERNET and TCP/IP protocols.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A computer-implemented method of expertise mapping comprising:
obtaining, from a communication application, user-defined auto-reply settings for a recommender using the communication application, said auto-reply settings including message body text for auto-reply messages;
extracting recommendation data from the auto-reply settings; and
updating an expertise database based on recommendation data extracted from the auto-reply settings.

2. The method of 1 wherein obtaining, from a communication application, user-defined auto-reply settings for a recommender comprises:
sending a request to the communication application for user-defined auto-reply settings; and
receiving, from the communication application and responsive to the request, the user-defined auto-reply settings for the recommender.

3. The method of claim 1 wherein extracting recommendation data from the auto-reply settings comprises identifying a recommended person from a contact recommendation directive in the message body text.

4. The method of claim 3 wherein updating an expertise database based on the recommendation data comprises adding or updating an expertise mapping for the recommended person.

5. The method of claim 3 wherein extracting recommendation data from the auto-reply settings further comprises identifying a subject associated with the recommended person from the contact recommendation directive in the message body text.

6. The method of claim 5 wherein updating an expertise database based on recommendation data comprises adding or updating an expertise mapping including the recommended person and the identified subject associated with the recommended person.

7. The method of claim 3 wherein extracting recommendation data from the auto-reply settings further comprises identifying the recommender.

8. The method of claim 7 wherein updating an expertise database based on the recommendation data comprises adding or updating an expertise mapping corresponding to the recommender.

9. The method of claim 7 further comprising identifying a subject associated with the recommender from an existing expertise mapping.

10. The method of claim 9 wherein updating an expertise database based on the recommendation data comprises adding or updating an expertise mapping including the recommended person and the identified subject associated with the recommender.

11. The method of claim 3 wherein:
the expertise mapping includes a competency score for the recommended person; and
adding or updating an expertise mapping in an expertise database based on the recommendation data comprises generating the competency score.

12. A computing device for an expertise mining system, the computing device comprising:
a communication interface for communicating with an application server executing a communication application; and
a processing circuit configured to:
obtain, from a communication application, user-defined auto-reply settings for a recommender using the communication application, said auto-reply settings including message body text for auto-reply messages;
extract recommendation data from the auto-reply settings; and
add or update an expertise mapping in an expertise database based on recommendation data.

13. The computing device of 12 wherein the processing circuit is configured to obtain the user-defined auto-reply settings for a recommender by:
sending a request to the communication application for user-defined auto-reply settings; and
receiving, from the communication application and responsive to the request, the user-defined auto-reply settings for the recommender.

14. The computing device of claim 12 wherein:
the recommendation data comprises a recommended person; and
the processing circuit is further configured to identify the recommended person from a contact recommendation directive in the message body text.

15. The computing device of claim 14 wherein the processing circuit is further configured to update the expertise database by adding or updating an expertise mapping including the recommended person.

16. The computing device of claim 14 wherein:
the recommendation data further comprises a subject associated with the recommended person; and
the processing circuit is further configured to identify the subject from the contact recommendation directive in the message body text.

17. The computing device of claim 16 wherein the processing circuit is further configured to update the expertise database by adding or creating an expertise mapping including the recommended person and the identified subject associated with the recommended person.

18. The computing device of claim 14 wherein the recommendation data further comprises an identity of the recommender associated with the auto-reply settings.

19. The computing device of claim 18 wherein the processing circuit is further configured to update the expertise database by adding or updating an expertise mapping including the recommender.

20. The computing device of claim 18 wherein the processing circuit is further configured to identify a subject associated with the recommender from an existing expertise mapping.

21. The computing device of claim 20 wherein the processing circuit is further configured to update the expertise database by adding or updating an expertise mapping including the recommended person and the identified subject associated with the recommender.

22. The computing device of claim 14 wherein:
the expertise mapping includes a competency score for the recommended person; and
the processing circuit is further configured to update an expertise database based on the recommendation data by generating the competency score for the expertise mapping.

23. A non-transitory computer-readable medium storing executable program code that, when executed by a processing circuit in an expertise mining system causes the computing device to:
obtain, from a communication application, user-defined auto-reply settings for a recommender using the communication application, said auto-reply settings including message body text for auto-reply messages;
extract recommendation data from the auto-reply settings; and
update an expertise database based on recommendation data extracted from the auto-reply settings.
